(19) United States
(12) Patent Application Publication
(10) Pub. No.: US 2008/0102953 A1
(43) Pub. Date: May 1, 2008

(54) TOOTHBRUSH AFFECTING GAME PLAY

(75) Inventor: Charles P. Schultz, North Miami Beach, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/555,115

(22) Filed: Oct. 31, 2006

(51) Int. Cl. A63F 13/00

(52) U.S. Cl. 463/37

(57) ABSTRACT

A brush, that includes a bristle support member (205) and at least one bristle (210) attached to the bristle support member. The brush also includes at least one sensor (115) that detects motion of the brush and generates corresponding motion signals. A processor (110) can process the motion signals to generate gaming signals (160) and a gaming adapter (155) can communicate the gaming signals to a gaming device (165). The processor and gaming adapter can be positioned, at least in part, within the bristle support member. The brush also can include a timer (145) that generates timing signals. The processor can process the timing signals to limit a duration of game play. The processor also can process the timing signals to limit a number of gaming sessions in a period. Further, the gaming adapter can stop communicating the gaming signals after a timeout of the timer.

### BACKGROUND OF THE INVENTION

1. Field of the Invention

The present invention generally relates to brushes and, more particularly, to brushes that include electronic devices.

2. Background of the Invention

It is widely understood that regular brushing of ones teeth provides a number of health benefits. For instance, regular brushing reduces the risk of tooth decay and chronic gingivitis. A number of studies also have shown a link between healthy teeth, healthy gums and a healthy heart. One study in particular found that the bacteria that cause gum disease also can lead to a thickening of artery walls; a condition associated with heart attack and stroke.

Children, especially toddlers and pre-teens, commonly are reluctant to properly brush their teeth on a regular basis. To these children, brushing their teeth is often considered a chore akin to cleaning their room or taking out the garbage, and they frequently fail to brush unless reminded by their parents to do so. When they do brush, they tend to rush and fail to properly clean their teeth. Thus, there is a long standing need for a means of enticing children to properly brush their teeth on a regular basis.

### SUMMARY OF THE INVENTION

The present invention relates to a brush that includes a bristle support member and at least one bristle attached to the bristle support member. The bristle support member can include a first portion to which the bristle is attached. The first portion can be detachable from a second portion of the bristle support member. The brush also can include at least one sensor that detects motion of the brush and generates corresponding motion signals. A processor can process the motion signals to generate gaming signals. The gaming signals generated by the processor can affect a gaming parameter of a game element. A gaming adapter can communicate the gaming signals to a gaming device or a plurality of gaming devices. The processor and gaming adapter can be positioned, at least in part, within the bristle support member.

The brush also can include a sensor that detects moisture, pH, temperature, a chemical marker or an RFID tag and generates corresponding sensor data that is processed by the processor to affect at least one gaming parameter. The processor further can track usage of the brush and generate corresponding values or data that affect performance of a game element.

The brush can include a timer that generates timing signals. The processor can process the timing signals to limit a duration of game play. The processor also can process the timing signals to limit a number of gaming sessions in a period. Further, the gaming adapter can stop communicating the gaming signals after a timeout of the timer.

The present invention also relates to a method of controlling game play. The method can include receiving sensor data correlating to motion of a brush, processing the sensor data to generate gaming signals, and communicating the gaming signals to a gaming device. Processing the sensor data to generate the gaming signals can include generating gaming signals that correspond to motion of the brush. Generating the gaming signals can include generating signals that affect at least one gaming parameter.

Values correlating to usage of the brush can be stored. The usage can be determined by processing the sensor data or received audio signals. A duration of game play can be limited. For example, in response to a timeout of a timer, communication of gaming signals from a gaming adapter can be ceased. A number of gaming sessions in a period also can be limited. Usage of the brush can be tracked and values or data that correspond to the tracked usage can be generated. Generating the gaming signals can include processing the values or data such that the performance of a game element controlled by the gaming signals correlates to the values or data.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 depicts a perspective view of a brush that is useful for understanding the present invention; and

FIG. 3 is a flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a brush which is also a gaming input device. The brush can include sensors that detect one or more parameters, for instance motion of the brush, and generate sensor data. The sensor data can be processed to generate gaming signals that are communicated to a gaming device as gaming inputs. The gaming inputs can affect gaming activities on the gaming device, for example to control virtual game elements. In one arrangement, the brush can be a toothbrush, and motion of the toothbrush can be translated into motion or movement of virtual game players or virtual game objects.

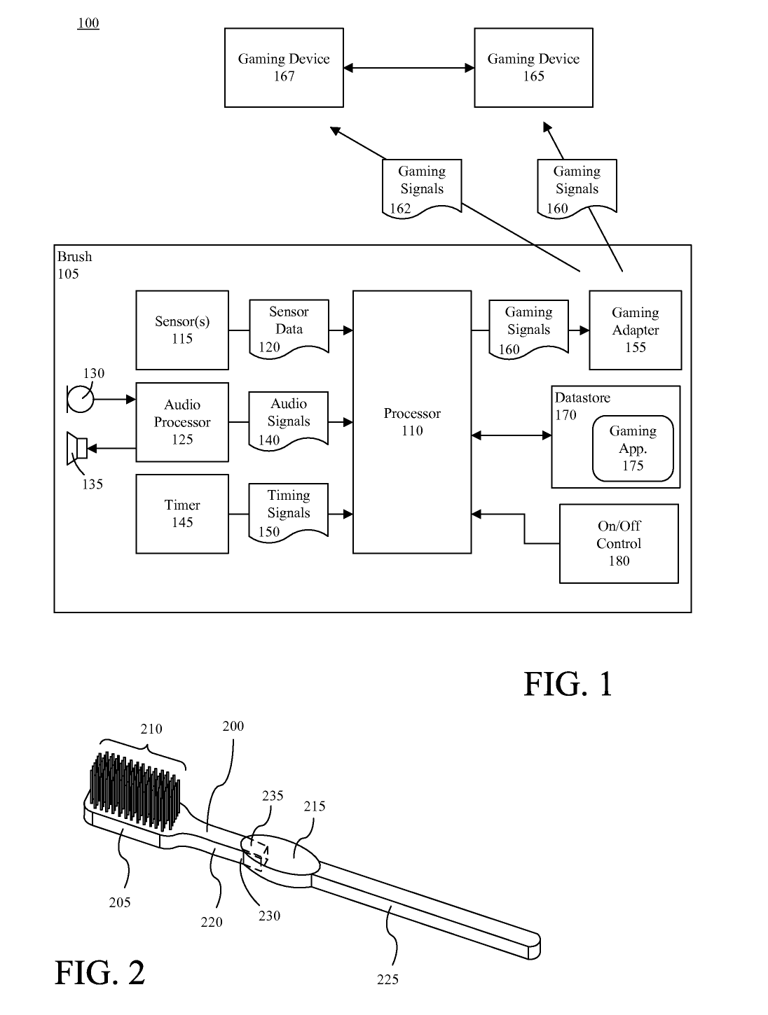

FIG. 1 depicts a communications system 100 that is useful for understanding the present invention. The communications system 100 can include a brush 105. The brush 105 can be a toothbrush, a hair brush, a cleaning brush, a scrub brush, or any other type of brush. The brush can include a processor 110. The processor 110 can comprise, for example, a central processing unit (CPU), a digital signal processor (DSP), an application specific integrated circuit (ASIC), a programmable logic device (PLD), a plurality of discrete components that cooperate to process data, and/or any other suitable processing device.

The brush 105 can include one or more sensors 115. The sensors 115 can detect any of a myriad of measurable parameters and generate corresponding sensor data 120. For example, the sensors 115 can include motion sensors that detect motion of the brush 105 and generate signals corresponding to the detected motion (i.e. motion signals). Motion can be detected along one, two or three axes. For example, the motion sensors can detect side-to-side and up-and-down motion. Similarly, a flexure sensor can be provided to detect flexure of the brush 105. The sensors 115 also can include a moisture sensor, for example to detect moisture content in order to verify when the brush 105 is in use. A chemical sensor also can be provided to detect presence of certain chemicals, such as chemicals or chemical markers that may be contained in saliva or a cleaning agent (e.g. toothpaste). An RFID reader can be provided to detect an RFID tag proximate to the brush 105, for instance an RFID tag attached to a tube of toothpaste. Other suitable sensors can include a pH sensor that measures pH levels and a temperature sensor (e.g. thermocouple) that measures temperature. Still, a myriad of other sensors can be provided and the invention is not limited in this regard.

In one aspect of the inventive arrangements, RFID information and/or chemical markers in a cleaning agent detected by the sensors 115 can be processed to provide gaming advantages or abilities. For example, if a certain brand of toothpaste is detected, gaming advantages or abilities can be provided while a particular game is being played. Such a game can be one that is downloaded from the website of the toothpaste manufacturer.

The brush 105 further can include an audio processor 125 communicatively linked to an input audio transducer 130 (e.g. microphone). The audio processor 125 also can be communicatively linked to an output audio transducer 135 (e.g. loudspeaker). The audio processor 125 can be integrated with the processor 110, or provided as a separate component that is communicatively linked to the processor 110. The audio processor 125 can comprise a CPU, a DSP, an ASIC, a PLD, a plurality of discrete components that cooperate to process audio data, and/or any other suitable audio processing device.

The audio processor 125 can receive analog audio signals detected by the input audio transducer 130, convert the analog signals to digital audio signals 140, and communicate the digital audio signals 140 to the processor 110. In a further arrangement, the audio processor 125 can communicate analog audio signals to the output audio transducer 135, for example in response to a signal received from the processor 110. The audio processor 125 also can equalize input/output audio signals, filter input/output audio signals, or perform any other audio processing tasks. In one arrangement, the audio processor 125 can be configured to isolate those sounds associated with use of the brush 105, for instance the brushing of teeth.

The brush 105 also can include a timer 145. The timer 145 can include an oscillator, for instance a voltage controlled oscillator, or any other timing device that can communicate timing signals 150 to the processor 110. The processor can process the timing signals 150 in order to measure time and perform any other time related functions. In one arrangement, the timer 145 can be integrated with the processor 110.

The brush 105 also can include a gaming adapter 155 that receives gaming signals 160 from the processor 110 and communicates such signals 160 to a gaming device 165. The gaming device 165 can be a computer, game console, a game station, a mobile station (e.g. mobile telephone, mobile computer, personal digital assistant, and the like), a remote control (RC) toy, etc. In one arrangement, the gaming device 165 can be communicatively linked to another gaming device 167. The gaming adapter 155 also can communicate gaming signals 162 to the gaming device 167. In a further arrangement, the gaming device 165 also can be a game control unit that controls the other gaming device 167.

The gaming device 165 can process the gaming signals 160 to effectuate game play on the gaming device 165 and/or on the gaming device 167. Game play also can be effected on any other gaming devices to which the brush, gaming device 165 and/or gaming device 167 are communicatively linked. For instance, the gaming signals 160 can be processed to affect a gaming parameter of a game element. Examples of such gaming parameters can include, but are not limited to, speed, direction, range of motion, defensive capabilities, ability to withstand damage, offensive capabilities, ability to inflict damage, size, color, range of affect, rate of energy loss, amount of energy available for special abilities, increase or decrease in skills, or any other game functions. In one arrangement, parameters of game elements can directly correlate movements of the brush 105 as detected by the sensors 115.

The gaming signals 160 can be processed in real time, or stored to subsequently affect one or more future games. For example, the gaming signals can be stored on the gaming device 165, on the gaming device 167, and/or on the brush 105, for instance in a datastore 170. The datastore 170 can include one or more storage devices, each of which can include a magnetic storage medium, an electronic storage medium, an optical storage medium, a magneto-optical storage medium, and/or any other storage medium suitable for storing digital information. In one arrangement, the datastore 170 can be integrated into the processor 110.

The gaming adapter 155 can comprise a transmitter configured for wired and/or wireless communications. For example the gaming adapter 155 can communicate in accordance with a personal area network communications protocol, such as Bluetooth or ZigBee. The gaming adapter 155 also can communicate using any other communication protocol suitable for communicating with gaming devices, such as gaming consoles, mobile stations or RC toys. For instance, the gaming adapter 155 can include an RF transmitter known in the art of RC toys. In one arrangement, the transmitter can be a component of a transceiver.

In an arrangement in which the gaming adapter 155 includes a transmitter configured for wired communications, the transmitter can communicate with gaming devices using a suitable communications port. For example, the gaming adapter 155 can communicate using a universal serial bus (USB), an IEEE-1394 bus, or any other suitable wired communications link.

A gaming application 175 can be contained on the datastore 170. The processor 110 can execute the gaming application 175 to implement the processes and methods described herein. For example, at runtime the gaming application 175 can receive the sensor data 120 and/or audio signals 140 and generate corresponding gaming signals 160. The sensor data 120 can comprise motion signals that represent, for instance, translational movements (e.g. direction and range of brushing) and rotational movements of the brush 105. In one arrangement, sensor data 120 representing translational movements can be processed to generate gaming signals 160 that represent movement and/or speed. Sensor data 120 representing circular movements can be processed to generate gaming signals 160 that represent a change in direction or a turn. Still, the gaming application 175 can process the sensor data 120 in any other suitable manner and the invention is not limited in this regard.

The gaming application 175 also can process the timing signals 150. For example, the gaming application 175 can process the timing signals 150 in order to monitor how long the brush 105 is in use, a frequency of brush 105 use, or monitor any other time related parameters. In one aspect of the invention, the gaming application 175 can store values correlating to the usage of the brush 105 in the datastore 170. Such usage can be determined by processing the sensor data 120 and/or the audio signals 140 (e.g. the sound of brushing). The gaming application 175 can store values that represent a regularity in which the brush 105 is used, the number of times the brush is used in a given period, and the average duration of brush 105 use. The gaming application 175 also can evaluate such information, for example by determining a deviation of the frequency in which the brush 105 is used and/or a duration of each use, and store resulting data.

The values/data stored by the gaming application 175 can be processed to effectuate game play. For instance, values/data that indicate regular use of the brush 105 for a prescribed amount of time can be processed to select a high performance virtual game element, such as a high performance vehicle or a powerful weapon, or to provide a greater health status of a virtual character. Similarly, such values/data also can be processed to provide high performance in a toy, for instance to provide greater speed for an RC toy. Values/data that indicate infrequent use of the brush 105 and typically insufficient duration of use can be processed to select a low performance virtual game element, such as a vehicle that barely runs or a low power weapon, or to reduce the health status of a virtual character. Likewise, such values/data can be processed to limit a toys performance, for example to limit the speed of an RC toy. Accordingly, in an arrangement in which the brush 105 is a toothbrush, regular and proper brushing can be encouraged.

The gaming application 175 also can process the timing signals 150 to limit a duration of brush 105 usage or to limit the number of use sessions in a given period. For instance, the duration of game play can be limited to two minutes, three minutes, four minutes, or any other desired period. Similarly, the gaming sessions played can be limited to three games within a twenty-four hour period. Thus, if the brush 105 is a toothbrush, excessive brushing can be discouraged.

The duration of play and/or number of games played within a given period can be limited in any suitable manner. For example, the processor 110 can process the timing signals 150 to generate a timer. In response to a timeout of the timer, the sensors 115 can cease generating sensor data 120, the processor 110 can cease processing sensor data 120, and/or the gaming adapter 155 can cease transmitting the gaming signals 160. Such processes can be reinitiated at the beginning of a next defined period, for example at the beginning of a next twenty-four hour period.

In an arrangement in which the gaming adapter 155 includes a receiver that can receive signals from the gaming device 165, such signals can be processed by the gaming application 175 and/or the audio processor 125 to generate gaming sounds via the audio output transducer 135. Further, in an arrangement in which the receiver can receive signals from a plurality of different gaming devices 165, the gaming application 175 can be configured to select one or more of such gaming devices 165 to which to communicate the gaming signals 160. For instance, a spoken utterance received from a user via the audio input transducer 130 to select a gaming device 165 to be used. The spoken utterance can be processed using speech recognition, which can be included in the gaming application 175. In another arrangement, the gaming application 175 can synchronize the brush 105 with other brushes or gaming devices to facilitate multi-player games. Alternatively, such synchronization can be performed by the gaming device.

The brush 105 also can include on/off control 180. The on/off control 180 can comprise a switch or electronic circuitry that turns off the brush 105. In one arrangement, the on/off control 180 can automatically turn off the brush 105 after a period of inactivity, and automatically turn on the brush in response to sensor data 120 being generated.

In another arrangement, the brush may only contain some of the elements described. For example the sensors 115, timer 145, gaming adapter 155 may be contained in the brush, while the audio processor 125, the audio transducers 130, 135, datastore 170 and gaming application 175 may be contained on the gaming device 165. The brush 105 can communicate with the gaming device 165 to access functions of the devices and components contained thereon.

FIG. 2 depicts a brush 200 that is useful for understanding the present invention. The brush 200 can include a bristle support member 205 to which one or more bristles 210 are attached. The processor, gaming adapter, sensors, audio processor, audio transducers, clock, datastore and the on/off control can be positioned, at least in part, within the bristle support member 205, for instance within a first portion 215 or a third portion 225 of the bristle support member 205. In an arrangement in which the gaming adapter comprises a wireless transmitter, an antenna also can be positioned within the bristle support member 205. In such an arrangement, the bristle support member 205 can comprise a dielectric material. Alternatively, the bristle support member 205 can comprise a conductive material, in which case the bristle support member 205 also can function as the antenna.

A second portion 220 of the bristle support member 205 can be flexibly attached to the first portion 215 of the bristle support member 205. Further, the first portion 215 can be flexibly attached to the third portion 225 of the bristle support member 205. For instance, the bristle support member 205 may be configured to flex in regions proximate to the first portion 215. One or more of the sensors can be configured to measure an amount of flexure in the bristle support member 205.

The bristles 210 can be attached to the second portion 220 of the bristle support member 205, and the second portion 220 can be detachable from the first portion 215. For example, an end 230 of the second portion 220 can insert into a cavity 235 defined within the first portion 215. In another arrangement, a mechanical connector can attach the second portion 220 to the first portion 215. Accordingly, the second portion 220 can be replaced when the bristles 210 are worn.

Attributes and/or capabilities of the second portion 220 can be detected when the second portion 220 is connected to the first portion 215. For example, different styles of bristles 210 can dictate different brushing time recommendations. Likewise, whether the second portion 220 is powered to rotate or vibrate the bristles 210 during brushing also can dictate different brushing time recommendations. In addition, attributes associated with the second portion 220 can be processed to select a transmission protocol with which the gaming signals 160 are communicated. For instance, a first attribute associated a particular second portion 220 can indicate to communicate via Bluetooth, while a second attribute associated with another second portion 220 can indicate to communicate via WiFi. Such attributes can be processed to select any other functions of the brush 105 and the invention is not limited in this regard.

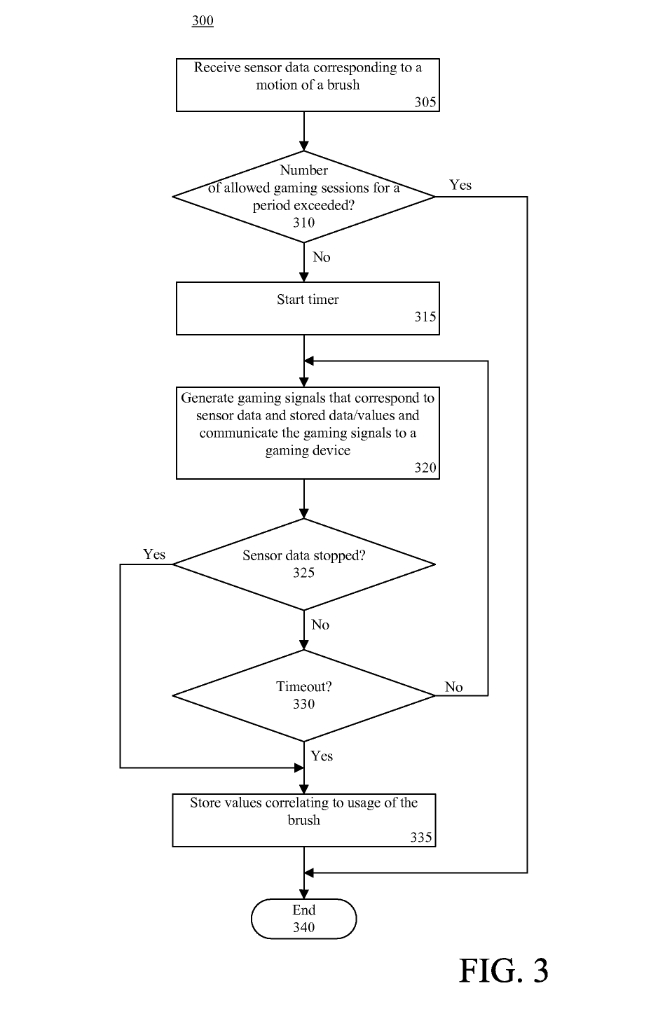

FIG. 3 is a flowchart presenting a method 300 that is useful for understanding the present invention. At step 305, sensor data corresponding to a motion of a brush can be received. The sensor data also can include data pertaining to moisture, flexure of the brush, or any other brush parameters that may be measured.

Referring to decision box 310, if a number of allowed gaming sessions or a total elapsed time of gameplay for a period have been exceeded, the process can proceed to step 340 and end. For example, the gaming session can end if three or more games have already been played in a twenty-four hour period. If the number of allowed gaming sessions has not been exceeded, the process can proceed to step 315 and a timer can be started. At 320 gaming signals can be generated and communicated to a gaming device. The gaming signals can correspond to the sensor data and stored data/values. The stored data/values can represent brush usage, for instance over a period. Examples of such a period can be one day, one week, one month, three months, six months, one year, and so on.

Proceeding to decision box 325, if the sensor data stops (e.g. the brush is no longer being used), at step 335 values correlating to usage of the brush can be stored. If the sensor data has not stopped, at decision box 330 a determination can be made whether the timer has timed out. If the timer has not timed out, the process can return to step 320 and the gaming signals can be generated and communicated. If, however, the timer has timed out, at step 335 the values correlating to usage of the brush can be stored and the process can end at step 340.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a midlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A brush, comprising:
a bristle support member;
at least one bristle attached to the bristle support member;
at least one sensor that detects motion of the brush and generates corresponding motion signals;
a processor that processes the motion signals to generate gaming signals; and
a gaming adapter that communicates the gaming signals to at least one gaming device.

2. The brush of claim 1, wherein the processor and gaming adapter are positioned, at least in part, within the bristle support member.

3. The brush of claim 1, further comprising:
a timer that generates timing signals;
wherein the processor processes the timing signals to limit a duration of game play.

4. The brush of claim 1, further comprising:
a timer that generates timing signals;
wherein the processor processes the timing signals to limit a number of gaming sessions in a period.

5. The brush of claim 1, further comprising:
a timer that generates timing signals;
wherein the gaming adapter stops communicating the gaming signals after a timeout of the timer.

6. The brush of claim 1, wherein the gaming signals generated by the processor affect a gaming parameter of a game element.

7. The brush of claim 1, wherein the processor tracks usage of the brush and generates corresponding values or data that affect performance of a game element.

8. The brush of claim 1, wherein the gaming adapter communicates the gaming signals to a plurality of gaming devices.

9. The brush of claim 1, further comprising a sensor that detects moisture, pH, temperature, a chemical marker or an RFID tag and generates corresponding sensor data that is processed by the processor to affect at least one gaming parameter.

10. The brush of claim 1, wherein the bristle support member comprises a first portion to which the at least one bristle is attached, the first portion being detachable from a second portion of the bristle support member.

11. A method of controlling game play, comprising:
receiving sensor data correlating to motion of a brush;
processing the sensor data to generate gaming signals; and
communicating the gaming signals to a gaming device.

12. The method of claim 11, wherein processing the sensor data to generate the gaming signals comprises generating gaming signals that correspond to the motion of the brush.

13. The method of claim 11, wherein generating the gaming signals comprises generating signals that affect a gaming parameter of a game element.

14. The method of claim 11, further comprising storing values correlating to usage of the brush.

15. The method of claim 14, further comprising determining the usage of the brush by processing the sensor data or received audio signals.

16. The method of claim 14, further comprising limiting a duration of game play.

17. The method of claim 14, further comprising limiting a number of gaming sessions in a period.

18. The method of claim 11, further comprising:
in response to a timeout of a timer, ceasing communication of gaming signals from a gaming adapter.

19. The method of claim 11, further comprising:
tracking usage of the brush; and
generating values or data that correspond to the tracked usage;
wherein generating the gaming signals comprises processing the values or data such that the performance of a game element controlled by the gaming signals correlates to the values or data.

20. A machine readable storage, having stored thereon a computer program having a plurality of code sections comprising:
code that receives sensor data correlating to motion of a brush;
code that processes the sensor data to generate gaming signals; and
code that communicates the gaming signals to a gaming device.
